(19) United States
(12) Patent Application Publication
(10) Pub. No.: US 2011/0261347 A1
(43) Pub. Date: Oct. 27, 2011

(54) Method for interferometric detection of surfaces

(75) Inventors: Ivan Kassamakov, Helsinki (FI); Juha Aaltonen, Helsinki (FI); Heimo Saarikko, Helsinki (FI); Edward Haeggstrom, Helsinki (FI); Kalle Hanhijärvi, Helsinki (FI)

(73) Assignee: UNIVERSITY OF HELSINKI, Helsinki (FI)

(21) Appl. No.: 13/133,659

(22) PCT Filed: Dec. 9, 2009
(86) PCT No.: PCT/FI2009/050993

§ 371 Date: Jul. 8, 2011

(30) Foreign Application Priority Data
Dec. 9, 2008 (FI) 20086180

(51) Int. Cl. G01B 9/023

(52) U.S. Cl. 356/51; 356/511

(57) ABSTRACT

The invention relates to a method for imaging a microfabricated device comprising at least one oscillating component. The method comprises stroboscopically illuminating in an interferometric setup said component in synchronized relationship with the excitation of the device, and detecting interference light in synchronized relationship with the illumination and excitation. According to the invention the component is illuminated at a wavelength band which is at least partly transmissible by the component, and the positions of at least two separate surfaces of the component of interest are determined based on the interference light detected at least at two temporal phases of excitation of the device. The invention provides an efficient method for in-depth characterization of micromechanical structures that provide only one-sided access during operation.

### FIELD OF THE INVENTION

The invention relates to interferometry, in particular Scanning White Light Interferometry (SWLI). In SWLI, a sample is illuminated in an interferometric configuration using broadband light in order to measure its 3D profile. In particular, the invention relates to a novel interferometric method.

### BACKGROUND OF THE INVENTION

SWLI is, as the name states, an interferometric measurement technique. Interference occurs, when two or more wavefronts coincide and form a resultant waveform. A well-known, most simple case is when two monochromatic waves interfere. In SWLI, contrary to this usual monochromatic light approach, low coherence (broadband) light is used. This has the effect that a spatially well-localized interference takes place. Unlike in e.g. laser-based phase-shifting approaches, SWLI does not suffer from phase ambiguity and height differences of surfaces can be measured with good accuracy and in-plane resolution.

Thick films (˜3 μm and larger) are used widely in the design and manufacture of Micro-Electro-Mechanical Systems (MEMS) and Micro-Opto-Electro-Mechanical Systems (MOEMS) devices, semiconductors and hybrid circuits. Accurate control over film thickness and uniformity is essential for maintaining device performance and achieving high-yield deposition processes.

SWLI is well-established for accurate static out-of-plane 3D profiling of MEMS devices (T. Dresel, et al., “Three-dimensional sensing of rough surfaces by coherence radar” Applied Optics, Vol. 21, Issue 7, p. 919, 1992). However, to improve MEMS and MOEMS manufacturing and device reliability there is a need to determine their mechanical properties during operation. In addition to static profiling, SWLI can be used also in dynamic measurements, i.e. for imaging an oscillating sample. In such measurements, SWLI is combined with a stroboscopic illumination synchronized with the sample oscillations (S. Petitgrand et al., “3D Measurement of micromechanical devices vibration mode shapes with a stroboscopic interferometric microscope” Optics and Lasers in Engineering Vol. 36, Issue 2, p. 77-101, 2001). In practice a short light pulse from a light emitting diode (LED) is produced at a certain phase angle of oscillation. While integrating over a number of periods, information is acquired only during the light pulses. If the pulse length is short compared to the oscillation period (for example <10%), and if the synchronization is stable, a quasi-static image is acquired at that phase angle. Changing the relative phase of illumination allows measuring an arbitrary part of the oscillatory motion. This allows determining dynamic mechanical parameters (e.g. maximum bending height of thermal bridges), which often differ from the static. It also allows verifying complex dynamic device models to some extent.

Known dynamic SWLI measurements are, however, relatively limited in their ability to characterize the operation of the sample as a whole. For example, the ultimate reason for low performance of a M(O)EMS device can often not be explained well using previously known measurements.

### SUMMARY OF THE INVENTION

It is an object of the invention to achieve a novel and more informative method for studying the mechanical properties of moveable components of M(O)EMS devices and the like samples during use.

The invention is based on the idea of
stroboscopically illuminating in an interferometric setup the component of interest in synchronized relationship with the excitation of the device at a wavelength which is at least partly transmissible by the component of interest,
detecting interference light in synchronized relationship with the illumination and excitation, and
determining, based on the light detected, the position of at least two separate surfaces of the component of interest at least at two temporal phases of excitation.

In particular, the interferometric setup is an SWLI setup comprising
a stroboscopically operable broadband light source,
a beam-splitter, and
an interferometric objective, which is moveable with respect to the sample for varying the depth of the focal plane of the objective at the sample region. This path modulation is usually accomplished with high precision piezoelectric translator.

The determination of the position of the at least two surfaces is determined with the aid of the above-mentioned path modulation, i.e., the relative displacement of the objective is with respect to the sample. A digital camera can be used to record the interferogram for each individual pixel of the camera. The actual relative height can thereafter be calculated pixel-by-pixel. This calculation is preferably based on calculation of envelope function(s) descriptive of the surface positions at said locations based on the interferograms recorded, and in particular the contrast of interference fringes of the interferograms. For example, a so-called five-sample-adaptive (FSA) nonlinear algorithm can be used for envelope calculation combined with filtering of measurement data. A detailed analysis method especially advantageous within the present invention is described in more detail below.

The measurement system typically also comprises a control unit for controlling the imaging sequence, that is, the timings of the light source, objective movement, sample excitation and detector with respect to each other, and, optionally also for recording the data obtained from the detector and/or calculation of the surface positions.

By means of the invention, the form of a plurality of surfaces contained in the sample can be measured in a dynamic situation. This allows one to study and understand the functioning (or malfunctioning) of MEMS devices more thoroughly. For example, a sole top surface measurement of a vibrating membrane of a defective MEMS device may not reveal the reason for the malfunction, because there may be a manufacturing error within the device, that is, below the top surface. A multiple-surface measurement gives more information on the operation of the device and assists in solving problems of this kind, for example. The method also offers a very effective tool for quality control in MEMS manufacturing.

Silicon is important material when making MEMS devices. It is opaque in the visible range, but it is transparent in the infrared range starting from the wavelength of approximately 900 nm, the transparency being at maximum at around 1200 nm. There are cases in which the profiles of both surfaces (the top and the bottom) must be measured. It is impossible to measure both the surfaces for devices which are created on opaque substrates by turning the device upside down. By extending the optical range of a SWLI instrument to NIR range, it is possible to, not only, measure both surfaces through the device, but also the inner structure of the MEMS device. In addition the stroboscopic measurement enables the measurement of moving or vibrating devices.

Thus, according to one embodiment, silicon components or other components exhibiting partial transmittance for IR light are measured. In this embodiment, an IR light source and IR detector are used. In particular, in the case of silicon components, a NIR camera is combined with a scanning interferometer and a stroboscopic NIR illumination unit to see through the component, which can be a moveable silicon membrane or cantilever of a MEMS device, for example. This allows measuring both the top and bottom surface profiles at once during membrane or cantilever movement. In particular, one can measure the movement of out-of-plane sample and thickness profiles of micron-scale devices, which are opaque in visible range. This solves the problem of obtaining accurate profile data of fabricated device structures to verify microfabrication and to validate finite element method (FEM) modelling. It also allows studying dynamic motion induced alterations of the fabricated structure to validate model predictions.

In general, the invention extends the use of scanning white light interferometers to in-depth characterization of micromechanical structures that provide only one-sided access during operation using conventional means. Thus, the interferometer instrument is used on moving samples in the optical NIR range to gain information on not only their outer surface, but also at least one interface inside the structure.

An optical profiler according to the invention measures thickness for every point in the field of view, highlighting variations in thickness and uniformity across an area typically up to 50 sq. mm. Additionally, the topography of both film surfaces is extracted, giving a comprehensive view of the sample. For comparison, two previously known thickness measurement techniques, reflectometry and ellipsometry, provide only a single average thickness value, with little indication of film uniformity. Optical profiling according to the invention offers several other advantages over these methods as well. Where an ellipsometer is limited in vertical range to thicknesses of a few microns in M(O)EMS devices, the present optical profiler's range extends to several millimeters.

Further embodiments and advantages of the invention are described in the following detailed description with reference to the attached drawings.

### BRIEF DESCRIPTION OF THE DRAWINGS

FIG. 1. shows a schematic block diagram of stroboscopic SWLI setup according to one embodiment of the invention.

FIG. 2 illustrates as a graph the timed relationship between stroboscopic signal, sample drive voltage and camera exposure.

FIG. 3 shows an interferogram in one location (pixel) (a), a envelope value through a linear cross section of the sample (b), and a 3D presentation showing the height of top and bottom surfaces of an oscillating sample (c).

FIG. 4 shows the interferogram of FIG. 3a, showing the thickness d′ calculated based on the interference fringes.

FIG. 5 shows an illustration of peak detection.

### DETAILED DESCRIPTION OF EMBODIMENTS

The invention concerns a method for stroboscopic interferometric profiling of an oscillating object. In the method, the oscillating object is sequentially illuminated through an interferometric objective in synchronized relationship with the oscillation using a broadband pulsed light source for producing a plurality of interference patterns corresponding to at least two different oscillatory positions of the object. The interference patterns at each oscillatory position are detected using a two-dimensional detector having a plurality of pixels each measuring an interferogram corresponding to a specific location of the sample. The illumination wavelength band is chosen such that the object is at least partly transparent or translucent in that wavelength band for obtaining interference patterns contributed by at least two optically detectable interfaces of the object. According to the SWLI principle, the topological profiles of the at least two optically detectable interfaces are further calculated by analyzing contrast of the interferograms.

The wavelength band used in the measurement lies preferably in the visible (380-750 nm) or infrared (IR, 750 nm-1000 μm) range. According to a particularly preferred embodiment, the measurement is carried out at near infrared (NIR, 750 nm-2.4 μm) range.

The term “white light” (as in Scanning White Light Interferometry) as used herein is equivalent to term “broadband light”, in contrast to monochromatic light as in lasers. Thus, the term covers broadly any such multichromatic range of optical radiation for which the reflectance of the surfaces of interest of sample is substantially non-zero. Typically, the bandwidth of light is at least 100 nm, in particular at least 300 nm.

The term SWLI refers to the interferometric technique known per se, which includes illuminating the sample with white (i.e. broadband) light in an interferometric setup using various distances of an interferometric objective and the sample and detecting the optical interference patterns affected by the sample. The image reconstruction is based on the fact that maximum interference contrast is obtained from a particular location of the sample when that location is in focus of the interferometric objective. One example of carrying out a SWLI measurement, as well as a preferred image reconstruction technique for use within the present invention is disclosed in the licentiate thesis of Aaltonen, Juha, Envelope peak detection in scanning white light interferometry, Helsinki, 2002, which is incorporated herein by reference. The principles behind SWLI are discussed, for example, in P. De Groot and L. Deck, “Interferograms in the spatial frequency domain,” J. Mod. Opt. 42(2), 389 (1995).

The term “interferogram” refers to a recording of an optical interference pattern caused from a light divided into a beam reflected from the sample and a reference beam not hitting the sample using an interferometer.

The term “micro” refers to structures having dimensions in the range of 1-1000 μm. The term “nano” or “sub-micron” refers to structures having dimensions in the range of 1-1000 nm.

The term “surface” is used to describe any optically detectable interface within the sample imaged. That is, not only solid matter-to-air/vacuum interfaces, but also interfaces between two different solid materials and reflecting light at the wavelength range used can be detected.

### Instrumentation

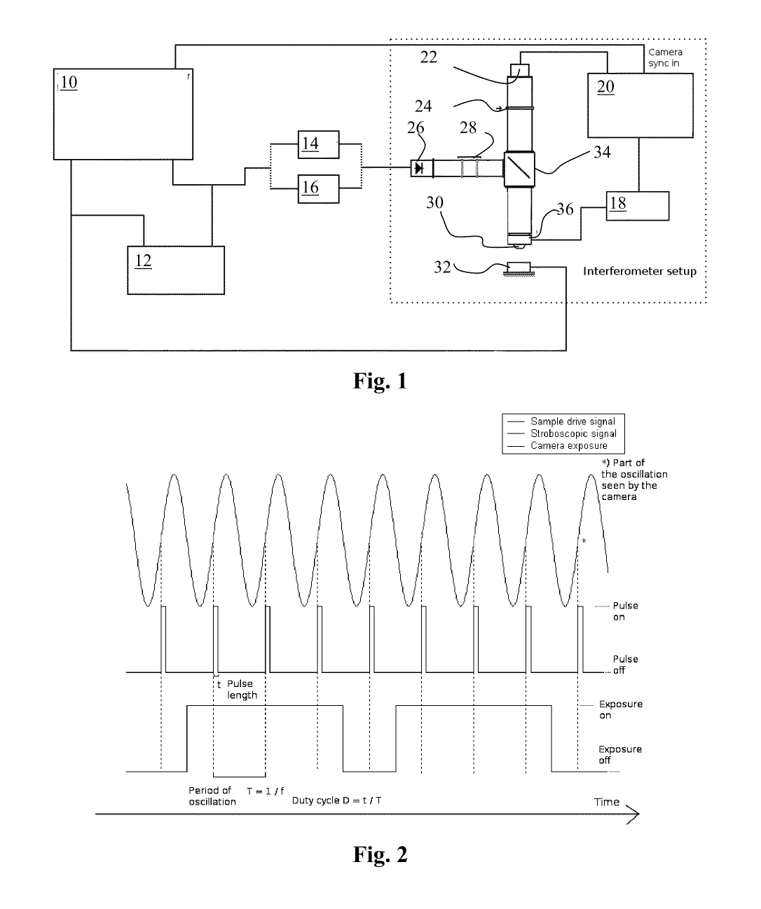

FIG. 1 shows an example of interferometric measurement configuration suitable for carrying out the present invention. A two-channel function generator 10 with frequency and delay control is provided for supplying the light source 26 and the sample 32 suitable excitation signals. The function generator also provides a trigger signal for a control unit 20 to allow, for example, synchronization of the camera. Excitation waveforms can be monitored using and oscilloscope 12. The light source 26 is driven through an amplifier 14 or a pulser 16. The light emitted by the light source 26 is guided through a collimator 28 to a beam-splitter 34. The interferometer also comprises an interferometric objective 30, which is mounted on a movable support 36, such as a piezoelectrically movable support. The support is operated by a controller 18 further controlled by the control unit 20 in synchronized relationship with the rest of the imaging components. The interference light is guided through a focusing lens to a detector 22 for recording the interferograms.

The stroboscopic illumination is most conveniently carried out using a LED of desired wavelength and bandwidth.

The function generator in the stroboscopic system can be a two-channel arbitrary function generator, such as Tektronix AFG3252, which provides desired signal waveforms for the illumination and the sample under study. A pulse voltage, with an adjustable duty cycle (pulse length as a fraction of period) is amplified with a pulse amplifier 14, which provides high current output for a single high intensity broadband LED. Although LEDs are usually specified for relatively small forward current levels in continuous operation, pulse mode enables the use of higher currents. The maximum current is preferably relatively high, such as 300 mA or more. Relatively high output power is advantageous, since the produced light pulses are short, typically less than 100 ns, in particular 40-60 ns. Typically, the used duty cycles are kept below 3%, since the uncertainty and fringe contrast lost caused by the stroboscopic pulse integration decrease with relative pulse length.

The interferometric objective is typically infinity-corrected and either Michelson or Mirau type. Additional collimation and focusing optics are used to facilitate the use of planar light. Standard interferometric objectives designed to visible range can be used also in the NIR range, because the optical transmission of such components is typically approximately 30% or more in that range. However, by using optics designed especially to the NIR range, the capability or the measuring device can further be increased, as the number of repetitions at each distance of the objective and the sample can be kept low.

The spatial modulation can be achieved by translating the objective relative to the microscope frame (and sample) with a piezoelectric scanner. The movement of the piezo may be corrected through feedback from capacitive displacement sensor, which reduces the uncertainty of the translation down to nm level.

The interferometric image can be recorded with a semiconductor detector, such as a high speed monochrome CCD camera or an InGaAs detector.

Image acquisition and piezo-control are handled by a control computer, on which a software serves as the interface between external peripherals and the user.

The sample can be driven with a number of periodic waveforms, of which sinusoidal voltage is the most frequently applied. Square wave voltage has also been used in determining the samples responsiveness to sudden changes in drive signal. In order to minimize the unnecessary load for the generator, a buffer amplifier is used. Additional voltage gain can be applied at the amplifier stage.

According to one embodiment, the light source and other optical parts are mounted on bridge-shaped frame situated above the sample holder. Such bridge-construction has proven to be stable, and thus it functions as a vibration dampener.

At a general level, important factors in a successful stroboscopic measurement are: short enough duty cycle of the light pulse, sufficient illumination intensity, accurate phase angle control, and synchronization of the camera, sample and illumination frequency.

### Imaging Process

The device under measurement is actively driven with a selected signal. The piezo scanner moves the image plane of the interferometric objective through all the points of interest in the measurement area of the device. Frames are saved at specific steps during the z-direction scan (usually the step size is ⅛ of the mean wavelength of the light source). After the measurement the frames form the interferograms for every pixel of the imaging system. The interferograms are processed individually in a plurality of steps. First the interferograms are low pass filtered to remove the low frequency intensity changes. Next the surfaces are searched using rough maximum contrast method, and then envelope is fitted to that part of the interferogram only, and the more precise z-location is determined using a specific algorithm, such as a Larkin algorithm (K. G. Larkin, “Efficient nonlinear algorithm for envelope detection in white light interferometry,” J. Opt. Soc. Am. A 13, 4, 832-843 (1996)). The number of interfaces or surfaces of the device or sample is deducted from the interferogram by using specific parameters that define the threshold for the detection and the minimum distance between interferogram peaks. The contrast of the interferogram can be used as a parameter to quantify the reliability of the measured z-location. The result of the measurement can be presented with e.g. profile lines, 2D and 3D graphs. The refractive index of the measured device or sample must be known in advance or it must be measured separately in order to have real dimensions for the measured thicknesses, no only relative positions of the surfaces.

FIG. 2 shows as a graph an exemplary imaging sequence. The graph shows a sample drive signal stroboscopic illumination signal and the timing of camera exposure. The camera is in active state for several illumination periods and thus integrates the interference signal over several illumination cycles. As the sample movement is synchronized with the illumination, the sample is seen at each exposure cycle in a certain position and a “still” image can be reconstructed. The illustrated imaging sequence is repeated for a plurality of displacements of the interferometric objective for obtaining full 3D data, as explained above.

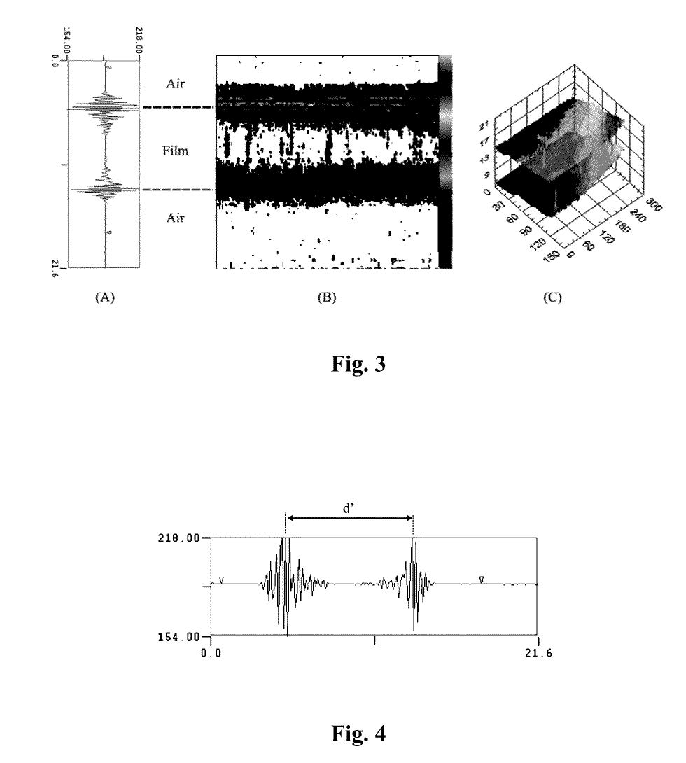

For obtaining information of a film structure, the optical system is translated vertically such that both the upper and lower film surfaces pass through focus of the interferometric objective. For each location in the field of view, two sets of interference fringes develop during the scan: one corresponding to best focus at the top surface of the film, the second corresponding to the lower surface of the film. An example of such fringes can be seen in FIG. 3. The purpose of further data analysis is to determine the film thickness based on these fringes. According to one embodiment, this analysis comprises first determining the maximums of the two fringe envelopes and calculating the distance between them. This distance is divided by the film's index of refraction to determine its thickness.

The smallest measurable thickness is dependent upon the magnification objective used its depth of focus and film's index of refraction. A 50× objective, because of its shorter depth of focus and high numerical aperture (N/A), can resolve small distances between the two fringe sets and can therefore characterize thinner films, typically down to 3 μm.

In order for the analysis to determine the film thickness, the group index of refraction must be well-known and homogenous. If the index is not known, a step measurement from the film to the substrate can be made, and the index can be back-calculated. The thickness d of the film is calculated from the formula d′=d*n, where n is the refractive index of the film and d′ is the distance between the centers of the fringe patterns. For films with a high index of refraction, thicknesses as low as 2 μm can be measured if fringe envelopes do not overlap. For thinner films, the fringe envelopes may overlap. In such cases the principles disclosed, for example, in the following articles can be used: Daniel Mansfield, The distorted helix: thin film extraction from scanning white light interferometry, Proc. SPIE 6186, 618600, 2006; Mike Conroy and Daniel Mansfield, Scanning interferometry: Measuring microscale devices, Nature Photonics 2, 661-663, 2008; or Kim S-W, Kim G-H Kim, Thickness profile measurement of transparent thin-film layers by white-light scanning interferometry, Appl. Opt. 38 5968-5973, 1999.

As concerns the accuracy and reliability of the measurement, it is preferable that the scanning procedure is kept as short as possible, that is, the number of frames should be small. Further, the calculation of the envelope function and height information should be as efficient as possible and the height extraction algorithm should be accurate and tolerant of noise and any systematical errors. In the following, some theory of SWLI imaging and preferred techniques are described for enabling one to meet these goals in the framework of the present invention.

### SWLI Theory

Maxwell equations, and thus the wave-equation, which describes the propagation of electromagnetic radiation (light), are linear. Principle of linear superposition thus holds, and the resultant waveform is simply given by the vector sum of the original waves. Considering a simple case of coherent planar waves in one dimension, the electric field is given by (equivalently, the magnetic field could be considered):

E₁=A₁e^{iω}^{₁}^{t+δ}^{₁},E₂=A₂e^{iω}^{₂}^{t+δ}^{₂}

ωᵢ are the angular frequency, t is time and δᵢ are phase difference. Aᵢ are the individual amplitudes The sum of the fields is thus:

E=A₁e^{iω}^{₁}^{t+δ}^{₁}+A₂e^{iω}^{₂}^{t+δ}^{₂}

Frequency of visible light is too high for any detector to follow (550 THz), so the time-average of the field intensity (Poynting vector) is observed. Averaging the square of the sum gives:

I∝ [symbol] E² [symbol] = [symbol] E₁² [symbol] + [symbol] E₂² [symbol] +2 [symbol] E₁E₂ [symbol] =I₁+I₂+I₁₂

Iᵢ and I₂ are the respective averages of the independent waves. The interference term I₁₂ is interesting here, a relatively short direct calculation shows (assuming E₁=E₂), that is can be written as:

I₁₂=2 cos(δ)

Considering a Michelson interferometer, where the difference in phase is caused by the asymmetry in the optical path lengths. The phase difference is given by:

$$δ = \frac{2 π}{λ} Δ z$$

Where λ is the wavelength and Δz is the difference in optical path length. Clearly the interference terms is zero, when the phase difference between waves is π, and at maximum, when the phase difference is zero. Therefore one can measure the difference in optical path length by measuring the intensity of the interference. It is possible to measure 3D profiles based on this principle. Monochromatic source, described in the setup in non-ideal though, since, the cosine function gives out the same intensity for every 2π period. This problem with phase ambiguity is the main reason why laser based interferometers can in practice not be used in measuring long distances (more than λ/4).

Concept of coherence is useful, when broadband light sources are considered. Two waves are defined to be coherent in respect to each other, if their phase difference is constant, as in the example above. For a real-world light source, the degree of coherence can be portrayed through the concepts of coherence time and length. Coherence time is the time interval in which the phase relation between multiple waves is constant. Coherence length is the respective distance the wave travels during the coherence time. For coherent sources, such as lasers, the coherence length ranges from centimeters to meters, while for incoherent sources of which an incandescent light bulb is a classical example, it can be short as one micrometer. Coherence length is roughly inversely proportional to the line width of the source spectrum.

When considering the interference with incoherent light, the effect of coherence length is evident. Interference can be observed only for coherent wavefronts, that is, for partially incoherent light, interference only occurs within the scale of coherence length. In practical terms, this means that, the arms of the interferometer should be matched with a precision of coherence length. Since broadband light is composed of multiple wavelengths, the functional form of the white light interference pattern can be constructed from sum of separate interferences between different wavelength components. In reality, the spectrum is a continuous in terms of wavelength, and thus the measured signal can be calculated from an integral over the source bandwidth, where the spectral distribution function V(k) (k=2π/λ) is a weight function:

$$I ( z ) = {\int }_{Bandwidth} ⌊ R + Z + 2 \sqrt{RZ} cos [ 2 k ( h - z ) + ϕ ] ⌋ V ( k ) d k$$

Where R and Z are the effective reflectivity and transmissivity of the optical setup (including contribution from beam splitter and the sample etc.). The signal is calculated only for a single difference is z. The envelope of the interferogram has its maximum, when the displacement parameter z is zero. The condition is fulfilled, when the arms of the interferometer are matched. The reference and sample wavefronts travel equal distance, and the phase difference is thus zero. The light interferes, when the arms are matched with the precision of the coherence length.

Finally, it can be shown, that the actual shape of the white light interferogram, observed from the detector is:

g(x,y,z)=a(x,y)+b(x,y)c[z−2h(x,y)] cos [2πw₀−α(x,y)]

Where a(x,y) is the background offset related to the non-interfering parts of the wavefront. Reflected beam intensity determines b(x,y), and c(z) is the envelope. The height of the sample surface is h(x,y). The surface is parallel to the (x,y)-plane and z-direction represents the surface profile. The phase term, in this case includes the familiar term from the optical path difference, which corresponds the relative height of the sample surface.

### Analysis of the Measurement Data

The above principle is used to establish the measurement procedure. We are after the peak of the envelope function, but in order to calculate it, we will have to record interferogram intensities from multiple phase differences using, for example, the instrumentation described above.

Spatial sampling considerations are important aspect of the SWLI measurement. According to a preferred embodiment the interferogram is sampled at 90° intervals respect to the fundamental spatial frequency (λₘ/8). It can be shown, that this kind of optimization leads to significant improvement is efficiency, while retaining adequate level of precision (see description of FSA calculation below). However, also over-sampling is possible to improve the precision, while increasing the requirement of computer processing time and data storage.

A number of different approaches can be used to extract the height information from the interferogram. An exact, but computationally intensive method involves Fourier transforming the recorded interferogram to frequency domain. After certain processing has been applied, the signal is transformed back to spatial domain, which gives the envelope. Even, when a relatively efficient fast Fourier transform (FFT) algorithm is used, the computational burden is significant.

### Preferred Mode of Processing

A much more efficient algorithm is a realization of a Hilbert transform envelope calculation. The envelope can be calculated from the modulus of the analytic representation of the signal. Analytic representation of a real function consists of a real part, which is the function itself. The magnitude of the imaginary part is the Hilbert transform of the original signal. A continuous Hilbert transform produces a 90° phase shift to a wideband signal, which is not needed for the band limited interferogram. Thus the computational efficiency can be improved through applying a certain pair of discrete filter functions, while the Fourier method requires order of long operations. The discrete, efficient realization needs to give the correct values for the envelope only in the immediate vicinity of the peak. Part from being efficient, the envelope detector, often referred to as five-sample-adaptive (FSA) nonlinear algorithm, is also tolerant of sampling error. The gradient of the Fourier transform of the filter functions are nearly zero, and vary only slowly with the fundamental spatial frequency.

The square of the envelope is given by (assuming sampling at λₘ/8):

M²∝(I₂−I₄)²−(I₁−I₃)(I₃−I₅)

The peak position, which equals the surface height, can be calculated from the envelope, with a weighted symmetrical fit of a Gaussian function. The peak position is thus:

$${z}_{p} = 0.4 \frac{{λ}_{m}}{8} ( \frac{{L}_{1} + 3 {L}_{2} - 3 {L}_{4} - {L}_{5}}{{L}_{1} - 2 {L}_{3} + {L}_{5}} )$$

The FSA algorithm is extremely efficient and tolerant of sampling errors and is thus preferably used in the data analysis phase of the present method.

The accuracy can be improved further by combining the FSA algorithm with a phase shifting technique. Phase shifting has been used extensively with laser-based interferometers. It has a potential for better accuracy than the envelope detection, but is suffers from 2π ambiguity. The resulting phase information must be unwrapped in order to extract the real height data. Unwrapping can be achieved through using the height data calculated from the FSA, as a reference. Any noise in the reference data (FSA) will impair the ability of the unwrapping procedure. Not all 2π jumps are removed, which decreases the usefulness of the phase shifting approach.

The FSA and phase shifting algorithms assume that the intensity data is sampled at fourth of the spatial frequency (λₘ/8). Any error in sampling will result in systematic error in the final height data. For this reason, the FSA-algorithm is preferred over the pure phase shifting approach, since it has been found to be less vulnerable to sampling errors. Also, the phase shifting combination is more susceptible to noise. The unwrapping procedure cannot perfectly eliminate the 2π ambiguity, if the reference data from FSA is noisy.

### Example

### Processing of the Interferogram

Six parameters can be used to define how the interference peaks are detected:

### 1. EnvelopeRise

This parameter defines how much (in percent) the envelope value must rise from the lowest value to allow the next peak to be detected.

### 2. MinSeparation

This parameter defines the minimum distance between the peaks in micrometers.

### 3. PeakThreshold

This parameter defines the threshold for a peak to be detected.

### 4. MaxInterfaceNum

This parameter defines the maximum number of interface or peaks to be detected.

### 5. 3RDBetween

This Boolean parameter instructs the search algorithm to first find the two biggest peaks, and limit the search between these two peaks when searching for the last, 3rd peak.

### 6. RI

This parameter defines the refractive index of the transparent medium.

### The Procedure

First all the needed variables: envelope value (EVal), peak position (IPos), and z-values are allocated.

Every pixel of the captured frames is processed in the same way.

1. Get the interferogram values from the captured frames and mark the full envelope as the valid range for the search of the interference peaks.

2. The envelope is created using the following equation (Larkin 1996, see above):

$$EVal [ fr ] = \frac{1}{2} \sqrt{\vert \begin{matrix}{( I [ fr - 1 ] - I [ fr + 1 ] )}^{2} - \\ ( I [ fr - 2 ] - I [ fr + 0 ] ) ( I [ fr + 0 ] - I [ fr + 2 ] )\end{matrix} \vert} , \qquad ( 1 )$$

where fr is the frame number index and I[n] is the intensity of the pixel (n=0, 1 . . . N). The maximum value of the envelope and the position is also detected and saved.

3. Peak positions are searched for until enough peaks (i.e. equal to MaxInterfaceNum) are detected.

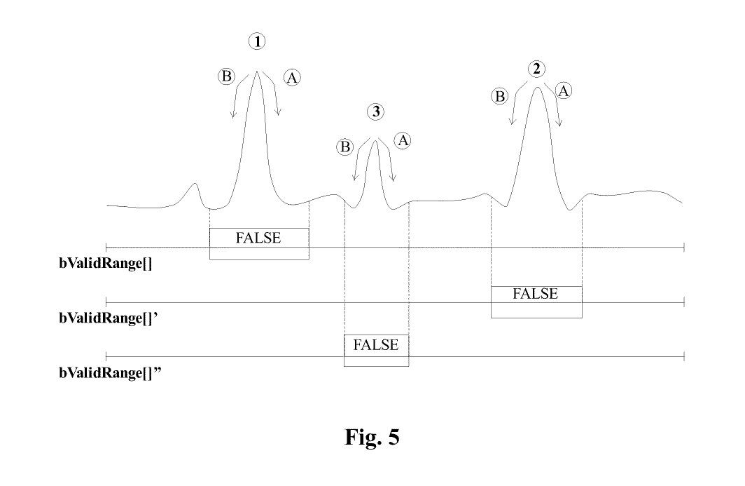

With reference to FIG. 5, the procedure for finding the peaks is following:

The boolean array bValidRange[ ] contains the part of the interferogram in which new peaks can be detected. When peaks are found, the boolean values in the neighborhood of the peak are set to false to exclude (i.e. invalidate) that area for additional search.

The peaks are found in height order from the highest to the lowest (in FIG. 5 the order is 1, 2, and 3). The detailed description of procedure to find the peaks in the FIG. 5 is the following:

The steps 1-3 are repeated until enough peaks are found (i.e. equal to MaxInterfaceNum).
1. Find the maximum peak value of the interferogram where bValidRange has the value of true. Save this (local) maximum value of the envelope and its location (i.e. the frame number).
2. Mark the peak neighborhood as invalid by setting the corresponding bValidRange values to false. This is done by first going down the right slope of the peak until requirement of the minimum separation of the peaks is fulfilled (using the parameter MinSeparation). The lowest value of the envelope is recorded during the examination, and when the envelope value has risen the defined (i.e. EnvelopeRise) percent from the lowest value, the invalidating is stopped. The right slope of the peaks is processed in the same the way.
3. If the parameter 3RDBetween is set to true by the operator, and already two peaks have been found, the area before the first peak and after the second peak is marked invalid, so that the third peak will be found in between the two, first and biggest peaks.

The rough positions for the peaks are now detected. Next the finer positions are calculated using the procedure described in Aaltonen 2002 (see above).

At the moment the parameter PeakThreshold is not implemented. It can be used to sort out the areas with one or more interfaces detected. This means that the measured area may contain single interface surfaces and transparent layers.

The parameter RI can be used in the definition of MinSeparation to distinguish the optical thickness of the layer from the mechanical.

The embodiments and examples given above and the attached drawings are not intended to limit the scope of the invention, which is defined in the following claims The claims should be interpreted in their full breadth taking equivalents into account.

1. A method for imaging an microfabricated device comprising at least one oscillating component, comprising the steps of;
stroboscopically illuminating in an interferometric setup said component in synchronized relationship with the excitation of the device,
detecting interference light in synchronized relationship with the illumination and excitation,
illuminating the component at a wavelength band which is at least partly transmissible by the component, and
determining, based on the interference light detected, the positions of at least two separate surfaces of the component of interest at least at two temporal phases of excitation of the device.

2. The method according to claim 1, wherein the interferometric setup is a scanning white light interferometer (SWLI) setup.

3. The method according to claim 2, wherein the SWLI setup comprises
a broadband light source,
a beam-splitter, and
an interferometric objective, which is moved with respect to the device for varying the position of the focal plane of the objective at the region of the component imaged.

4. The method according to claim 3, wherein the interferometric objective is mounted on a piezoelectrically movable holder.

5. The method according to claim 1, wherein the microfabricated device is a micro-electromechanical semiconductor chip.

6. The method according to claim 1, further comprising using illumination light at the infrared (IR) region, in particular near infrared (NIR) region.

7. The method according to claim 6, wherein said component comprises silicon.

8. The method according to claim 1, further comprising controlling the imaging using a control unit capable of controlling the timings and/or frequencies of the illumination, device excitation, detector readout, and interferometric setup with respect to each other, and, optionally also for recording the data obtained from the detector.

9. The method according to claim 1, further comprising;
recording a plurality of interferograms are using the detector, which comprises a plurality of pixels each corresponding to a specific in-plane location of the component,
calculating envelope functions descriptive of the surface positions at said locations based on the interferograms recorded, preferably using the Larkin method.

10. The method according to claim 9, further comprising using Hilbert transform envelope calculation.

11. The method according to claim 9, further comprising using five-sample-adaptive (FSA) nonlinear algorithm for envelope calculation.

12. The method according to claim 9, further comprising;
low pass filtering interferograms formed by the interference light,
analyzing the interferograms for detecting regions of the interferograms roughly corresponding to positions of sample surfaces, and
calculating the envelope functions to said regions for determining accurate positions of the surfaces of the component.

13. The method according to claim 1, further comprising calculating the thickness of the component imaged from the positions of the surfaces of the component using the refractive index of the component.

14. The method according to claim 1, wherein the positions of the surfaces for a plurality of temporal phases of oscillation are stored in arrays where the array element values correspond to local heights of the surfaces and, optionally, the element values are scaled to a range suitable for visualization.

15. The method according to claim 1, wherein the number of surfaces is deducted from interferogram using parameters that define the threshold for the detection and the minimum distance between interferogram peaks.

16. The method according to claim 1, comprising detecting the position of at least one interface inside the component.

17. The method according to claim 16, comprising detecting the position of outer surfaces of the component and at least one material interface inside the component.
